(19) United States
(12) Patent Application Publication
(10) Pub. No.: US 2018/0111135 A1
(43) Pub. Date: Apr. 26, 2018

(54) NOZZLE WITH AUTOMATIC ADJUSTABLE APERTURE

(71) Applicants: Arthur J. Zito, Jr., Swampscott, MA (US); William R. Zito, Millersville, MD (US)

(72) Inventors: Arthur J. Zito, Jr., Swampscott, MA (US); William R. Zito, Millersville, MD (US)

(21) Appl. No.: 15/567,861

(22) PCT Filed: Jan. 18, 2016
(86) PCT No.: PCT/US16/13772

§ 371 Date: Oct. 19, 2017

Related U.S. Application Data
(60) Provisional application No. 62/104,850, filed on Jan. 19, 2015.

(51) Int. Cl. B05B 1/32; B05B 1/24; B05B 12/12; A01C 23/00

(52) U.S. Cl. CPC B05B 1/326; A01C 23/007; B05B 12/12; B05B 1/24

(57) ABSTRACT

A nozzle with aperture adjusted automatically in response to an independent variable. Nozzle is defined as a protruding part, conduit, valve, vent, vane, funnel, flap, or diaphragm, connected to a tube, pump, canister or source of fluid, which is any liquid, gas or flowing mixture, for the purpose of controlling the rate of flow, direction, pattern, composition or other features of the flow or mixture. The nozzle of this invention comprises an adjustable aperture and the apparatus of this invention is comprised of the nozzle and the circuitry or processor to receive a signal from at least one sensor and automatically adjust the aperture in response to the signal. The invention can be used with any variety of fluids that are liquid, gas, flowing semi-solid or combination. A preferred embodiment employs the signal from a water vapor pressure sensor to adjust the aperture of the nozzle to disperse a droplet size that creates drizzle.

### FIELD OF INVENTION

This invention relates to systems and methods to adjust a nozzle, conduit, valve, vent, vane, funnel, flap, or diaphragm to disperse fluids. Nozzles are common in fuel propulsion systems, such as rockets, jet engines and automobiles. Nozzles are also common in water pumping systems, such as for irrigation, cleaning, manufacturing and firefighting. Nozzles are commonly used to extrude food products, for spray painting or inkjet printing and to control gaseous mixtures such as for welding, scuba diving or HVAC humidifiers.

### BACKGROUND OF THE INVENTION

Even a mixture of large and small size rocks can behave as a liquid, as evidenced by several landslides that flowed for a distance over dry land like flash floods, destroying homes. Therefore any flowing material is considered a fluid. The nozzle and fluid pressure exert control on the rate of flow for a fluid through an orifice. Once the nozzle has been designed, then typically fluid pressure is controlled and adjusted to achieve a desired effect. The nozzle also exerts control on the direction and pattern of the fluid dispersed. Direction, pattern, position, trajectory, distance, range and quantity or volume are all dependent variables of the pressure, fluid and nozzle characteristics; these aspects are all affected by the dispersion activity directly. The measurement of these aspects will therefore be affected by the dispersion activity that occurs, and we would define these aspects as dependent variables. An independent variable exists and acts separately from the model or method of other variables proposed or measured. In a statistical or mathematical model, we measure the group of “other” variables that are dependent or affected by the independent variable. If we set up a matched control group where the independent variable is held steady or we measure the group of dependent variables before and after a state change for the independent variable, this will help measure the accuracy and effectiveness of the model. For this invention, our independent variable is an object, action or event that occurs or acts separately from the apparatus and separately from the fluid dispersed. When dispersing water, the external water vapor pressure is an independent variable that affects whether a droplet size will create fog or mist or drizzle. By measuring water vapor pressure and adjusting nozzle aperture the apparatus can consistently deliver the droplet size for the desired state of fog or mist or drizzle desired. The benefits for water dispersion include visual effects, shading, and transfer of fluid to specific areas. A corresponding benefit may result for other materials such as gasoline or paint or food paste. Other instruments can be layered into the device, such as heating elements to heat the fluid. In alternate embodiments, the measurement of remote variables can be processed by a central computer and direction provided as a composite signal to a group of nozzle apertures that achieve an overall strategy. The list of aspects provided for fluid dispersion are examples and not limiting. Water vapor pressure is also an example of an independent variable that may affect the fluid, dispersion and dependent variables, and therefore possible benefits, but water vapor pressure is not a limiting example.

### DESCRIPTION OF PRIOR ART

A variety of methods have been designed to adjust the aperture of a nozzle in order to further control the rate of flow or pattern. Most of these systems are using a manual adjustment or adjustment affected by the pressure within the nozzle. For example, Bullock's U.S. Pat. No. 3,977,608 describes adjusting the size of a dispersal orifice by means of a spring from the pressure within the nozzle, or by means of a manual thread. In another example, Modes' U.S. Pat. No. 4,121,762 describes a fluid flow device that is self-adjusting to the pressure of the flow, and can add a pneumatic thermostat to adjust the dimensions through pressure within the nozzle. In another example, Cline et al.'s U.S. Pat. No. 6,913,166 describes an apparatus for dispensing liquids with a number of feedback mechanisms, but specifically using pressure to control the pump rather than the valve. Another example is Tian's U.S. Pat. No. 7,938,337 that describes a nozzle with flexibly deformable sidewall to respond to internal pressure. With the advent of automatic control systems and sensors, a number of methods have been introduced to adjust fluid pressure, which together with a manually adjusted aperture can deliver a precise flow or pattern. A few mechanisms internally adjust an aperture as fluid pressure fluctuates, maintaining a steadier rate of flow. None of the methods previously introduced employ a sensor of an independent variable, adjusting the nozzle aperture automatically based on the signal from a sensor of object or action separate from the mechanism or from the fluid dispersed.

### SUMMARY AND OBJECTS OF THE INVENTION

In general, the apparatus of the present invention comprises a nozzle, adjustable aperture diaphragm, solenoid or motor, sensor, wiring and optionally a processor. The processor is present in an ideal embodiment, but is not required for a minimal embodiment. Sensors can be designed to send a signal, either on/off or proportional to a measurement, and then the signal can be used to activate or adjust a motor, solenoid or drive mechanism. The apparatus will include the electronic circuitry to receive a signal that is based on external information or measurement by a sensor or device. It is possible to construct circuitry that interprets signals and gives direction to the mechanism or mechanical device that adjusts the aperture of the nozzle. It is also possible to include a processor or an electronic control board that interprets the signals from measuring devices and provides direction for the adjustment of the nozzle aperture.

The approximate aperture size for a nozzle to produce droplets within a target range can be determined. However, there is a small and sensitive difference between the droplet sizes that result in drizzle compared to mist or compared to fog. The droplet size is also dependent on the ambient water vapor pressure, which is a more determining factor as to whether fog or mist will result. Commercial fog machines either depend on oil and other chemical mixtures, or rely on the constricted humidity conditions of a controlled, indoor environment. In the natural world, droplets within the range may result in rain or fog or just evaporate, depending on the relative humidity in the atmosphere. In fact, while meteorologists can cite a dew point for a given temperature, they find it difficult to predict where fog will actually occur. As a result, they will report “a chance of fog” or “the dew point is 42 degrees.”

H. W. Lull of the U.S. Dept. of Agriculture collected empirical measurements of the falling velocity for water droplets within the defined categories. This showed that drizzle would range from 0.1 millimeters to 0.96 millimeters in diameter, and then for mist down to 0.01 millimeters, and anything smaller than this would remain suspended as fog for 15 minutes even at a height of 10 feet. This illustrates that the approximate size of droplets can be determined, but you would need the more exact adjustment of droplet size to the exact water vapor pressure to ensure that the dispersed fluid creates mist or fog:

| | Intensity | Median | Velocity of fall | Drops per second |
|---|---|---|---|---|
| | inches/hour | diameter | feet/second | per square foot |
| | (cm/hour) | (millimeters) | (meters/second) | (square meter) |
| Fog | 0.005 | 0.01 | 0.01 | 6,264,000 |
| | (0.013) | | (0.003) | (67,425,000) |
| Mist | .002 | .1 | .7 | 2,510 |
| | (0.005) | | (.21) | (27,000) |
| Drizzle | .01 | .96 | 13.5 | 14 |
| | (0.025) | | (4.1) | (151) |
| Light | .04 | 1.24 | 15.7 | 26 |
| rain | (0.10) | | (4.8) | (280) |
| Moderate | .15 | 1.60 | 18.7 | 46 |
| rain | (0.38) | | (5.7) | (495) |
| Heavy | .60 | 2.05 | 22.0 | 46 |
| rain | (1.52) | | (6.7) | (495) |
| Excessive | 1.60 | 2.40 | 24.0 | 76 |
| rain | (4.06) | | (7.3) | (818) |
| Cloud- | 4.00 | 2.85 | 25.9 | 113 |
| burst | (10.2) | | (7.9) | (1,220) |

Source: Lull, H.W., 1959, Soil Compaction on Forest and Range Lands, U.S. Dept. of Agriculture, Forestry Service, Misc. Publication No.768

In addition, the dispersed mist or fog is a composite of different size droplets within a range. Larger droplets are impacted by pressure as they fall, then distort and break apart. These larger droplets are more likely to break apart where ambient air pressure is greater, and the larger droplets will also collide and break apart. Water droplets will also evaporate into gas and the hydrogen and oxygen atoms will recompose in molecules within the air. The longer that a droplet of fog or mist remains suspended and the smaller the droplet, the more likely it is to transform in this manner. Higher temperature and greater wind will also lead to greater and faster evaporation.

A preferred result is to have a majority of droplets within the target range: greater than 50% of all the droplets. To create a heavy mist of water that will remain suspended longer than 10 seconds but not evaporate, more than 50% of the droplets should be between the size of 0.05 millimeters and 0.5 millimeters. To deliver the preferred droplet size and overall plume of the dispersed fluid, the main variables are nozzle and aperture size, pump pressure, and surrounding relative humidity, while nozzle capacity and shape design have a smaller influence. If we hold the fluid pressure constant at 1000 psi, and weather conditions are within a typical range for a North American forest in the spring or fall season, then we know the preferred nozzle size will be greater than 1.0 mm diameter and less than 3 mm to produce droplets that result in drizzle. Existing equipment outside these ranges produce different results: commercial misters use a nozzle size that is 1 mm or smaller, at 1000 psi while commercial agricultural irrigators will use a nozzle size that is 4 mm or larger, at 1000 psi, and commercial cleaning or cutting water jets will use nozzle size smaller than 0.5 mm at 30,000 or more psi. As the air temperature increases or the water vapor pressure decreases then the size of the droplet dispersed must increase to release the same fog result. The nozzle must adjust over time proportional to the atmospheric conditions.

When dispersing water, the external water vapor pressure is an independent variable that affects whether a droplet size will create fog or mist or drizzle. To have a system measure water vapor pressure and adjust nozzle aperture to consistently deliver the droplet size for the desired state of fog or mist or drizzle can have advantages. To create an effective fog machine that could cover a broad, outdoor crowd without covering people with oil or smoke, you would need to adjust the nozzle aperture and continue to adjust the aperture as the ambient pressure changes. When spray painting the exterior walls of a building, a painter will adjust the nozzle to keep the right density of paint droplets on the surface, and the nozzle aperture required will change as the atmospheric conditions determine how quickly the paint evaporates or pools; an automatically adjusting nozzle can save the time and difficulty of test patches, and ensure that paint is applied and dries evenly over all the surfaces. Current irrigation systems are designed to eliminate the effect of wind, and then rely on duplicate coverage patterns of multiple sprinkler heads to reach all areas. However, this strategy can result in excess water to some areas and will not optimize the use of water for the precise needs of diverse plants. The use of adjusting nozzles designed to create a fine drizzle that can carry in the wind over a broader area can optimize the use of water as a commodity. In a similar way, an automatically adjusting nozzle can prevent undue water loss where a commercial farmer must leave his irrigation equipment running over the course of a day and does not have the ability to adjust the nozzles or turn it on and off from cool morning hours to the heat of the afternoon. A flower horticulturist that finds misters effective in an indoor greenhouse would not use the same equipment outdoors; without constantly adjusting the nozzle aperture, the mist would either be too fine and evaporate or it would be too dense and damage the flowers. It may be desirable to water one area, and then further irrigate an area adjacent or separate from the area where the apparatus sits or disperses the fluid, either to make the irrigation efficient or to irrigate an area that is not accessible to place a piece of apparatus or piping to the apparatus. Therefore an automatically adjusting nozzle can make misters more effective.

The collision of larger water droplets will shift a percentage of the droplets from a larger size to the preferred size within the target range. Creating a swirl or whirlwind while dispersing the fluid can increase this collision and maintain a tighter pattern for a longer duration. As some of the droplets evaporate, other droplets will reduce in size to retain a proportion in the target range. The nozzle can be shaped to vent the fluid in a cone or funnel, and the nozzle could be further spun to create a funnel cloud. The spin can be adjusted along with aperture, based on external factors, to achieve the desired effect. The impact to local weather would be tested. This tactic may provide a useful tool to pre-emptively dissipate the heat or moisture differences that lead to extreme weather. The shaped nozzle with spin or movement while adjusting the aperture is to disperse the fluid for an anticipated behavior over a period of time.

Water vapor pressure is an example of a naturally occurring independent variable. Other environmental factors or naturally occurring aspects that can serve as independent variables are sunlight, moisture, salinity, pH, wind or water current, or earthquake. The fluid may be water or sea water dispersed into a gas such as air, and the aperture is based on the amount of sunlight or soil moisture. The independent variable could be the presence or proximity of an object or creature, or the motion of this object or creature toward, away or across the field of sensing of the apparatus. The conditions or sensing of the natural phenomena, creature or object may be specific, for factors such as color, size, speed or species, or any combination thereof. With the right sensor and coding, a device could detect the approach of a cat, and activate the apparatus to spray water to dissuade the cat from approaching. Another device measuring the water vapor pressure could assist the adjustment of the aperture to consistently deliver mist that may be more visible and disorienting to the cat. In a similar fashion, a device that detects the approach of a shark and disperses air bubbles underwater may serve to help repel the shark. In a similar fashion, when an intruder or burglar is approaching a protected area, the apparatus can be activated with a mix or second fluid of paint included and the aperture adjusted for a broad pattern, for the purpose to mark the intruder that will enable tracking, potential capture or identification, or otherwise repulse and repel the intruder. An alternate embodiment could include food or smells to entice or attract people, creatures including insects or underwater organisms.

Other flow devices would benefit from the automatic adjustment. A truck dispensing salt on the highway is directed from headquarters to begin salting as a manager determines overall weather patterns and needs for traffic. From that point when the truck starts dispensing, the salt is delivered in a “shotgun” approach of putting a broad pattern at a consistent flow rate over miles of roadway. Some stretches of road may be dry due to heavy wind; salt deposited there is blown into the vegetation and causes harm. Other pockets where precipitation is pooling and temperature is lower and the incline of the roadway or curve makes it more treacherous would need more salt. A computer attached to sensors could take into account these factors and adjust the flaps immediately to more accurately apply salt where it is needed, and also reduce overall quantity and cost of the salt treatment.

Other instruments or features can be layered into the device, such as heating elements to heat the fluid. Salt that is heated or even misted as it is dropped may increase its adhesion in those areas where wind is likely to blow the salt away. In other zones, it may be desirable to increase coverage by adding a fan or blower. When dispersing water droplets, a fan will typically increase evaporation and evaporative cooling. Therefore a fan, blower or some wind instrument is also a feature or device that can be layered or integrated with the adjusting nozzle. Therefore an intermittent application according to conditions can improve performance. When a manager gives the “go” signal to groups of trucks in different regions of a state, he is making a composite judgment of the many variables of weather forecast, road types and commuter needs. In addition to satellite and permanent weather station readings, each truck can operate as a local and mobile weather monitoring station. Those weather measurements and forecasts could be tabulated from regional and local sensors, processed and analyzed by a central computer, and then projected across the local conditions, forecast and needs for the trucks. That information can be sent wirelessly to a receiver on each truck and automatically adjust the salt dispensing flaps for each device, delivering a robust, comprehensive strategy for salt application. The system can permit manual override by the central station manager or the local truck operator. The actual application and resulting road conditions can be monitored by each truck and transmitted back to the central computer. The computer can log activity of the nozzle along with the conditions and then the final results to build predictive models, refine the strategies employed, provide reports and further manage the devices.

It is therefore an object of the invention to automatically adjust the aperture of a nozzle, conduit, valve, vent, vane, funnel, flap, or diaphragm, based on at least one independent variable.

It is a further object of the invention to adjust the aperture of a nozzle based on at least one independent variable to disperse a target droplet size.

It is a further object of the invention to employ a shaped nozzle with rotation, spin or movement while adjusting the aperture based on at least one independent variable to disperse a fluid with an anticipated behavior.

It is a further object of the invention to include other devices or features such as heating elements or blowers with the adjusting nozzle that can optimize the characteristics and behavior of fluids dispersed.

It is a further object of the invention to network a system of apparatus units with adjustable apertures that will optimize the fluid dispersed in multiple areas or as a total strategy through selective activation, deactivation and adjustment of individual apparatus units.

It is a further object of the invention to log activity of each apparatus, aperture adjustment, and remote environment for management of the area, the apparatus and to inform interested parties.

The citations are specifically incorporated herein by reference for all that the citations disclose and teach. Other objects, features, aspects and advantages of the present invention will become better understood or apparent from the following detailed descriptions, drawings and appended claims of the invention.

### BRIEF DESCRIPTION OF THE DRAWINGS

FIG. 1 shows an axial section of a nozzle with adjusting diaphragm, a top plan view of the diaphragm and exploded perspective of the component parts of a nozzle with a radial diaphragm adjusting the aperture size according to a signal from a sensor.

FIG. 2 shows an axial section a nozzle, an axial section at an angle of an adjusting cover, and exploded perspective of the component parts of a nozzle where the aperture size can be adjusted through a sliding cover linked to a signal from a sensor.

FIG. 3 shows an axial section of a nozzle, an axial section at an angle of the adjusting cover, and exploded perspective of the component parts of an adjusting nozzle shaped to disperse a swirl or funnel cloud.

FIG. 4 shows a profile view, exploded perspective of the component parts and a top plan view of a salt dispenser with adjusting flap.

FIG. 5 shows a decision protocol for an individual truck apparatus similar to the embodiment as depicted in FIG. 4.

### DESCRIPTION OF PREFERRED EMBODIMENTS

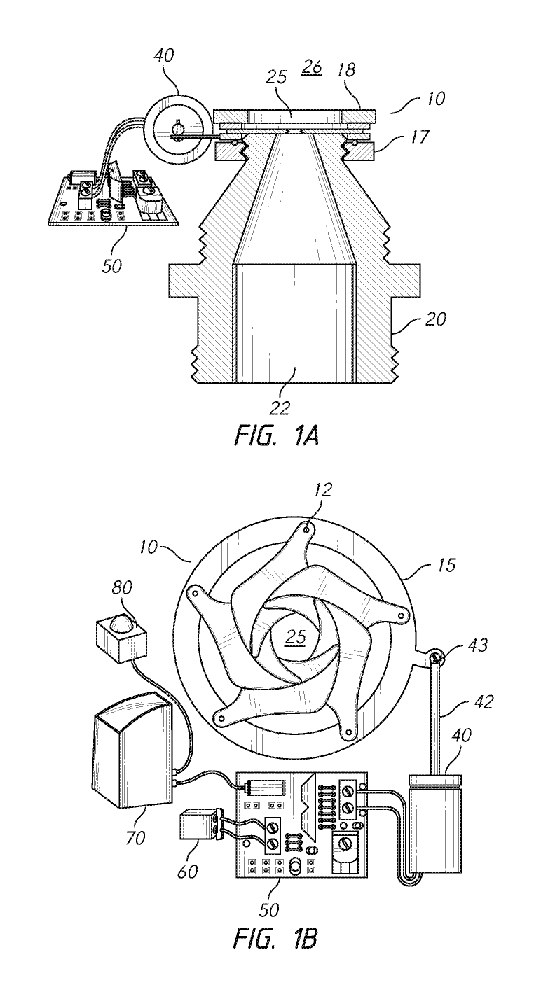

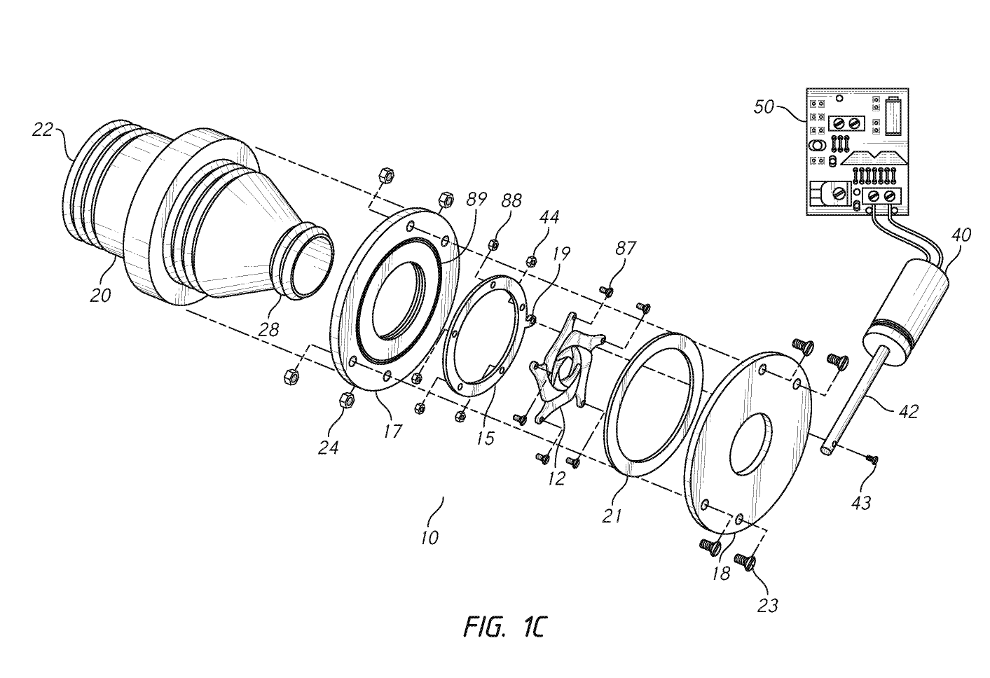

FIG. 1a shows an axial section of an adjusting diaphragm for a nozzle where the aperture can be changed according to a signal from a sensor. The adjusting diaphragm is indicated generally at [10]. As will be explained in detail, the adjusting diaphragm [10] controls the size of the aperture [25] for the nozzle [20] where fluid is dispersed. The adjusting diaphragm [10] is connected to a solenoid [40] and electrical control unit [50]. The adjusting diaphragm [10] is affixed to the nozzle [20] within a unit of retaining rings [17][18] that screw onto threads molded into the nozzle [20]. Preferably the diaphragm [10] and nozzle [20] are extruded plastic to provide a durable material impervious to water. Other materials could be molded to suit the chemical properties of other fluids, such as gasoline or ammonia. As identified in a study by Remy Bouet, “Ammonia: Large scale atmospheric tests,” page 105, an ammonia cloud dispersed through a jet tube “behaves like a heavy gas, and no rise in the cloud is observed.” There are real needs to shape and adjust a nozzle to both retain more ammonia as liquid and to disperse the cloud that does result so it does not cause concentrated damaged. In FIG. 1a, The nozzle [20] has further molded threads to permit attachments, braces, mounts or connecting valves or tubes as may be needed to hold the nozzle [20] in place and to supply fluid through the nozzle inlet [22]. Fluid will flow through the nozzle [20], through the adjusting diaphragm [10] and therefore the outlet [25] according to the pressure differential from the supply to the exterior [26].

FIG. 1b shows a top plan view of the adjusting diaphragm [10] with aperture or outlet [25] where fluid is dispersed and the connected solenoid [40] and electrical control unit [50]. The radial iris blades [12] are attached to the iris retaining ring [15]. The iris retaining ring [15] is connected to the armature [42] of a solenoid [40]. The radial iris blades [12] overlap. The armature [42] is connected to the iris retaining ring [15] with a bolt [43]. Each of the iris blades [12] is attached to the iris retaining ring [15] as further described in FIG. 1c. When the armature [42] is moved, the iris blades will enlarge or decrease the aperture [25] that is the nozzle outlet defined by the shape of the iris blades [12]. It is possible to design multiple iris blades with a circular shape so that the aperture is circular throughout its adjustable size range, rather than the roughly circular pattern depicted. The solenoid [40] is connected and controlled by an electrical control unit [50], such as the electrical control boards made by Arduino. A variety of electrical control boards are now readily available, and may be connected to a computer, other processor or even through electrical circuitry to deliver a signal originating from a sensor. In FIG. 1b, the electrical control unit [50] is powered by a battery [60], which serves to illustrate that a solenoid or other motor can be powered directly through an electrical control unit [50], although other power sources may be more appropriate to the overall design. Also attached to the electrical control unit [50] is a computer [70], which is also connected with a sensor [80]. An example sensor is the measuring device known as a Wide Angle High-Resolution Sky Imaging System “WAHRSIS”, described by Soumyabrata Dev et al. to construct for approximately $2500 (US dollars), which will measure precipitable water. In this embodiment, the sensor [80] is used to determine water vapor pressure and then adjust the aperture [25] for the finely tuned size required to disperse mist. As the independent variable of water vapor changes, the aperture [25] will adjust to maximize the amount of mist resulting from the fluid dispersed. This sensor [80] will send measurements to the computer [70], which will process the signals and send a signal to the electronic control unit [50], that together with the power supply [60] will activate and power the solenoid [40]. The signal from the sensor [80] could be a simple ‘1’ or ‘0’ as ‘on’ or ‘off’ that results in the solenoid [40] extending the armature [42] to close the aperture [25] to a fully closed position, or to retract the armature [42] to open the aperture [25] to a fully open position. The signal from the sensor [80] can also be a variable measurement that with the correct power and adjusting solenoid can deliver a range of extension, and therefore any finely graduated size of aperture [25].

When the armature [42] is extended or contracted, the armature [42] will rotate the iris retaining ring [15]. As the iris retaining ring [15] is rotated, each of the radial iris blades [12] is forced by the adjoining blades to collapse, or close the aperture [25] in the case of a counter-clockwise rotation. In the case of a clockwise rotation of the iris retaining ring [15], each of the radial iris blades [12] is pulled apart from the adjoining blades, to open the aperture [25]. That action can be further impelled and made precise through the use of a nub on the top surface of each of the iris blades [12] but is not necessary and not preferred in order to keep the surface of the iris blades [12] flush. The three dimensional overlap pattern of the iris blades [12] is sufficient to force the aperture [25] open and closed. Whether the iris blades [12] are termed blades, flanges, slides. leafs or similar, and whether such a design uses clockwise or counterclockwise motion to open or close the aperture is unimportant as the action and result will be the same.

The armature [42] is extended from the solenoid [40] when the solenoid receives an electrical signal. In this embodiment, the electrical signal is sent from the electronic control unit [50], although a signal could be sent directly from a sensor. The electrical control unit [50] in this depiction corresponds to an electrical control board made by Arduino, which would receive signals from a computer processor after analysis of sensor signals. When the computer processor determines from the sensor signals that the aperture should be closed, then the signal to the electrical control unit [50] can be turned off and the solenoid [40] will contract. This embodiment in FIG. 1 depicts a simplified construction of on/off where the aperture [25] is opened further or closed, and also requires continuous power to the solenoid to maintain the extended armature [42] and resulting constricted aperture [25]. However, there are a variety of variable extension solenoids and electronic control boards readily available in the public market to deliver variable extension of an armature for the full range of aperture size as needed.

FIG. 1c shows an exploded perspective of the component parts of the nozzle [20] with radial diaphragm [10], adjusting the aperture size according to a signal from a sensor. The nozzle [20] includes screw threads molded into the collar [28] to secure the lower retaining ring [17] that serves as a mounting bracket. Additional screw threads molded into the outer sleeve can secure the entire nozzle [20] to other parts of a complete device, including valves, pipes and pumps that would supply fluid into the nozzle inlet [22]. The radial iris blades [12] are attached to the iris retaining ring [15] that sits in the middle of the lower retaining ring [17] and the upper retaining ring [18]. The iris retaining ring [15] is connected to the armature [42] of the solenoid [40]. The radial iris blades [12] overlap. The armature [42] is connected to the iris retaining ring [15] with a bolt [43] through a hole [19] in the iris retaining ring [15] and fastened with a nut [44]. Each of the iris blades [12] is attached to the iris retaining ring [15] with a bolt [87] and nut [88]. The nut [88] of each bolt [87] holding each of the radial iris blades [12] will fit in a groove [89] of the lower retaining ring [17] that serves as a mounting bracket for the entire adjusting diaphragm [10], securing same to the nozzle [20]. The groove [89] acts to hold each nut [88] and therefore each of the radial iris blades [12] in the circular pattern as they move. Each bolt [87] is tapered to sit within its corresponding hole of the radial iris blades [12] so it will not impede rotation of the radial iris blades [12] and the iris retaining ring [15] below the upper retaining ring [18]. A plastic washer ring [21] can sit above the iris retaining ring [15] and fit within a matching groove underneath the upper retaining ring [18] to further facilitate the rotation of the iris retaining ring [15]. The upper retaining ring [18] is secured to the lower retaining ring [17] with four bolts [23] and nuts [24]. When the upper retaining ring [18] and lower retaining ring [17] are bolted then the rings will secure the iris retaining ring [15] and radial iris blades [12] within.

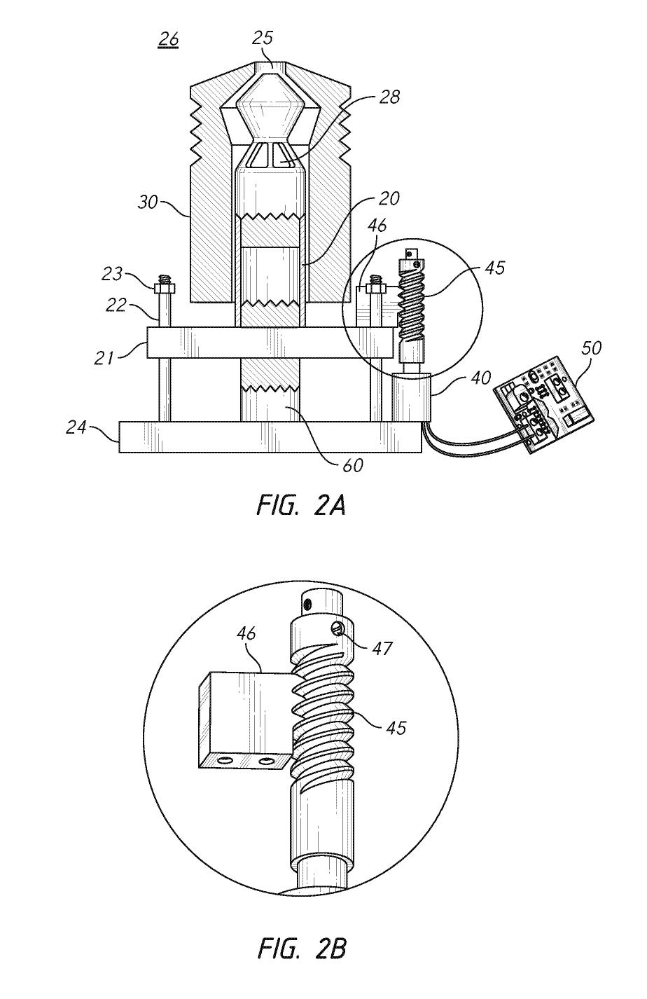

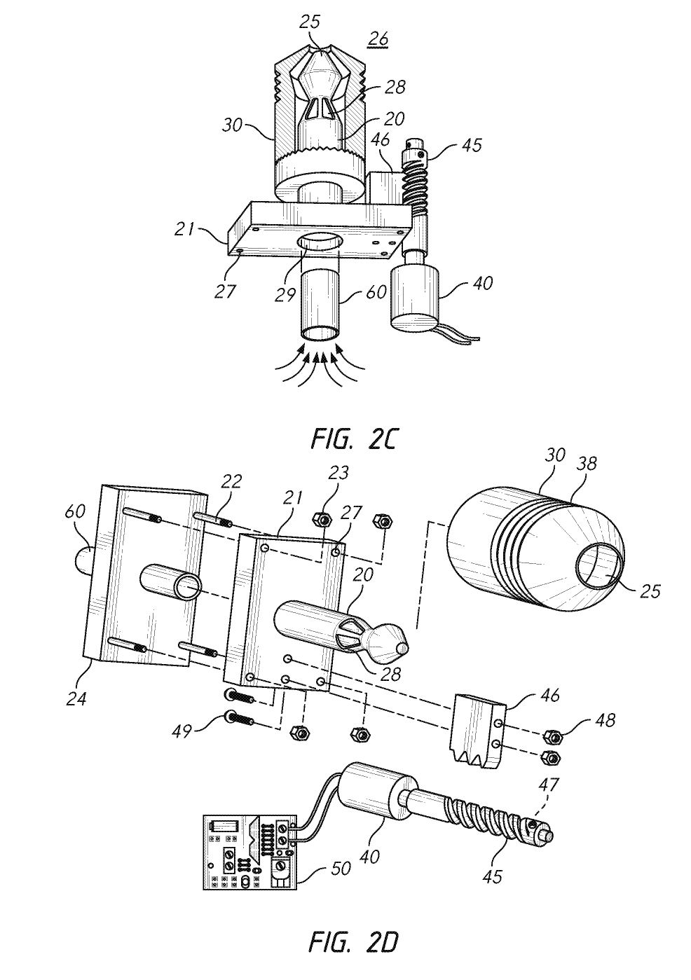

FIG. 2a shows an axial section of a nozzle [20] where the aperture size can be adjusted as the nozzle [20] slides within a cover [30] according to a motor [40] linked to a signal from a sensor. The nozzle [20] is attached to a platform [21] that slides on guide poles [22] and each guide pole [22] is fixed with a nut [23] that serves as guide stop for the platform [21]. The guide poles [22] are fixed to a mounting bar [24] that also holds the motor [40] steady and in a fixed position. The mounting bar [24] also holds the inlet pipe [60] in place and has a center hole for the pipe [60] to continuously stream the fluid. The inlet pipe [60] slides within the nozzle [20] as it is adjusted, but the inlet pipe [60] and nozzle [20] are engineered finely enough to provide a tight seal that prevents leakage as the fluid flows. An alternate embodiment may include O-rings, collars or pressure devices, as examples to further provide a seal for the fluid. FIG. 2a shows the nozzle [20] and the inlet pipe [60] with a cut-away view to illustrate that these are hollow and permit the fluid to flow within. The inlet pipe [60] includes vents [28] where the fluid will egress within the cover [30] and forced through pressure to escape through the outlet [25] to the exterior [26].

As a sensor sends a signal to the processor and results in a signal and power to the electronic control unit [50], then the electronic signal is relayed to the motor [40], which drives a screw shaft [45]. The screw shaft [45] is rotated according to the measurement of the independent variable, and in this way the aperture [25] can be adjusted continuously through the range of sizes desired. The screw shaft [45] rotates counterclockwise and will lift the screw bar [46] that is attached to the platform [21], sliding the nozzle [20] forward within the cover [30]. As the nozzle [20] slides forward within the cover [30], the aperture [25] is closed. By sending an opposing signal through the electronic control unit [50] to the motor [40], the motor [40] will rotate the screw shaft [45] in a clockwise direction, lowering the screw bar [46] and withdrawing the nozzle [20] from the cover [30], which will open the aperture [25].

The shape of the nozzle and the cover will force the fluid dispersed to converge as it escapes. The shape to achieve this effect is consistent throughout the aperture size from fully open to fully closed. One benefit of this convergence is to increase the collision of fluid droplets over time after dispersion. The collision will transform larger fluid droplets into smaller fluid droplets within the desired range of diameter, serving to optimize the percentage of droplets in the desired range even as some droplets evaporate. Another benefit of this convergence is to hold the plume or cloud of dispersed fluid more tightly. This benefit will be specific to some applications, such as where it is desired to have the plume stay together longer in wind, or to be carried more effectively by wind.

An alternate embodiment is to provide moisture to a broader or more remote zone being irrigated. A sensor could be soil moisture, but unlike conventional irrigation systems that turn a system's pressure on or off, this embodiment will adjust the aperture size. Irrigation systems will typically use fluid pressure to adjust trajectory, pattern or otherwise turn a system on and off, and the adjustment of fluid pressure will provide other benefits. The adjustment of aperture size provides specific benefits. In this embodiment, when a set of sensors measure the soil moisture of a remote area, read the water vapor pressure, and measure the wind direction and velocity, then this information can be processed by a computer to adjust an aperture to provide an optimum plume of mist that will be carried by the wind over the dry area.

An alternate embodiment employs this nozzle with a rocket to hit a moving object. One problem with a rocket hitting a moving object is the significant speed advantage of the rocket, which can unfortunately lead to a rocket missing its target as the rocket is not able to adjust its direction quickly enough should the target move. It would be a benefit in some situations if the rocket could reduce its speed differential in comparison to the target as the rocket closes its distance to the target. In this way, the rocket will have time to adjust its tracking. In this embodiment, the rocket would use a range finder or similar sensor to measure the distance to its target, the rate of decrease in that distance, along with other typical measurements such as the amount of three dimensional change by the target as a proxy indication of evasion. That information is provided to a computer that processes the measurements according to set points to decrease speed. Many rockets are using solid fuel or have designs that make variable thrust difficult. Adjusting the aperture may reduce thrust by opening the aperture where the dispersion pattern would provide less force against the air behind the rocket, or may reduce thrust by constricting the aperture where fuel is ignited as it leaves the aperture. Therefore the exact benefit of the aperture will be dependent on the rocket design, but the use of sensors to adjust the aperture will provide unique benefits to the rocket flight. In this embodiment, the nozzle is adjusted to change the thrust of the fluid or the thrust resulting from the chemical process that is occurring with the fluid expelled from the rocket. The independent variable could be any transportation vehicle or moving device.

In an alternate embodiment, a supervisor can remotely watch the flight of the rocket as the computer automatically adjusts the nozzle and flight, and the supervisor can choose to override the nozzle and the flight, now with an additional flight parameter to aid his objective.

FIG. 2b shows an expanded view of the screw shaft [45] and screw bar [46]. The expanded view illustrates how a counterclockwise rotation of the screw shaft [45] will lift the screw bar [46] and a clockwise rotation will lower the screw bar [46]. The screw shaft [45] is fixed on the motor shaft with a retaining screw [47].

FIG. 2c shows an axial section at an angle of the nozzle [20] where the aperture size can be adjusted as the nozzle [20] slides within a cover [30] according to a motor [40] linked to a signal from a sensor. The nozzle [20] is attached to a platform [21] that slides on guide poles that are positioned within the guide holes [27] of the platform [21]. The motor [40] drives the screw shaft [45] that elevates the screw bar [46] attached to the platform [21]. The cut-away view of the cover [30] reveals the nozzle [20] with windows or vents [28] where fluid will flow within the cavity of the cover [30] and escape through the aperture [25]. The inlet pipe [60] fits through the platform orifice [29] and as fluid flows through the inlet pipe [60] (flow shown as arrows) then the fluid will flow through the nozzle [20].

FIG. 2d shows an exploded view of the component parts of the nozzle [20] where the aperture size can be adjusted as the nozzle [20] slides within a cover [30] according to a motor [40] linked to a signal from a sensor. The inlet pipe [60] is attached to a mounting bar [24] and has guide poles [22] fixed in place. The inlet pipe [60] fits through an orifice in the bottom of the platform [21] that slides on guide poles [22] that are positioned within guide holes [27] of the platform [21]. Each of the guide poles [22] is secured with a nut [23] that also serves to limit the movement of the platform [21]. The nozzle [20] is affixed to the platform [21]. The nozzle [20] has windows or vents [28] where the fluid will flow. The nozzle [20] will slide within a cover [30] and the cover [30] can be screwed into a more complete unit or apparatus with the screw threads [38]. The fluid will flow from the windows or vents [28] within the cover [30] and be forced through the aperture [25]. The screw bar [46] is attached to the platform [21] with bolts [49] placed up through the platform [21] and secured with nuts [48]. An electronic control unit [50] is wired to the motor [40], which will rotate the screw shaft [45]. The screw shaft [45] is fixed on the motor shaft with a retaining screw [47]. When the screw shaft [45] is rotated, this will raise or lower the screw bar [46], moving the nozzle [20] within the cover [30], which will close or open the aperture [25].

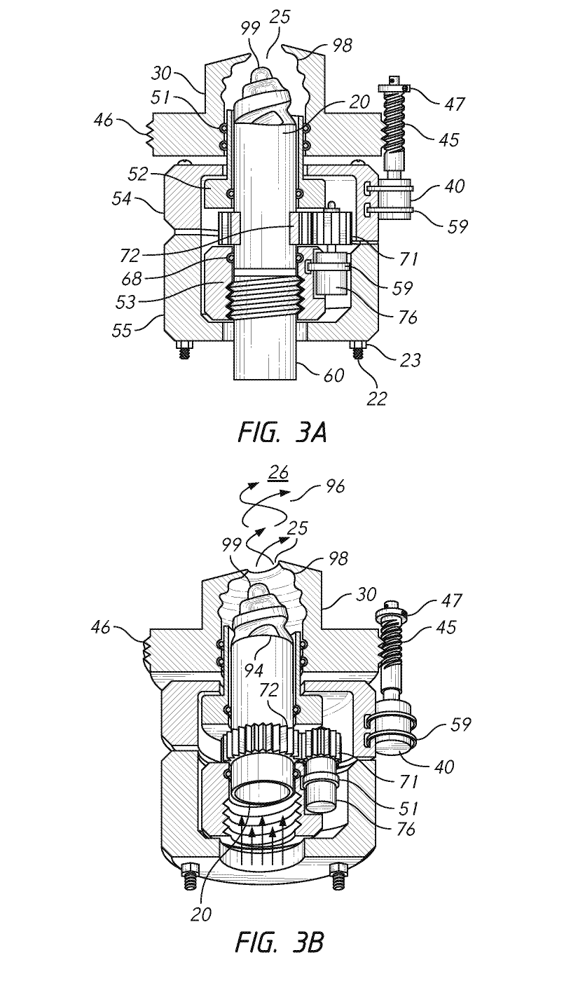

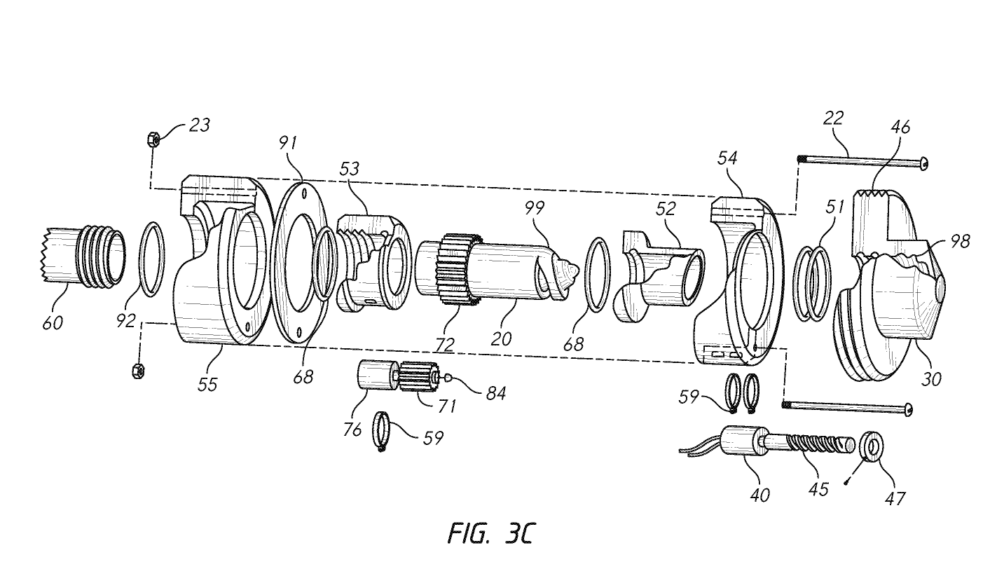

FIG. 3a shows an axial section of an adjusting nozzle [20] shaped to disperse a swirl or funnel cloud. The nozzle [20] is rotated by the gear [72] on the nozzle [20], driven by the gear [71] on a motor [76]. The aperture [25] is adjusted in unison by rotating a screw shaft [45] that raises or lowers a cover [30] over the nozzle [20].

The inlet pipe [60] has molded screw threads that secure an inner bracket [53]. The motor [76] that rotates the nozzle [20] is secured to the inner bracket [53] with a band or tie [59]. The nozzle [20] is held flush by the several brackets and sleeves to the inlet pipe [60] spaced with a rubber grommet or washer band that is more clearly described in FIG. 3c. An O-ring [68] within the inner bracket [53] surrounds the nozzle [20] to ensure a tight fit that prevents leaks. The motor [76] rotates a gear [71] that is interlocked to the gear [72] on the nozzle [20]. The gears and nozzle [20] are held in place by an inner sleeve [52] that includes an O-ring [68] to help the nozzle [20] turn and ensure no leak of fluid. The construction of nozzle [20] and rotation motor [76] and inner bracket [53] and inner sleeve [52] is held together by an outer lower bracket [55] and an outer upper bracket [54] that are bolted together with bolts [22] and nuts [23]. The motor [40] that moves the cover [30] is secured to the outer upper bracket [54] with bands or ties [59]. The motor [40] rotates a screw shaft [45] that is interlocked to the screw threads [46] on the cover [30]. The screw shaft [45] is fixed on the motor shaft with a retaining ring and screw [47]. The cover [30] retains O-rings [51] to slide easily on the inner sleeve [52]. The nozzle [20] features a shaped cap [99] that will disperse the fluid in a swirl pattern within the cover [30], with the objective to be further directed by the molded shape [98] inside the cover [30] so that the plume of fluid dispersed will swirl. The nozzle [20] cap is shaped in a spiral with outlet orifices in a spiral pattern and the orifices angled, slanted and shaped to fit consistently within that spiral pattern, and the cap [99] is shaped with spiral cavities for the purpose to create a swirl dispersion pattern. The force or flow of the fluid may be further sufficient to generate that swirl dispersion pattern into a funnel cloud that lifts pressure in the outer walls while causing descending pressure within.

FIG. 3b shows an axial section at an angle of a section of the adjusting nozzle [20] to specify the motion of the nozzle [20] and cover [30] to disperse a fluid in a swirl or funnel cloud. The nozzle [20] is rotated by the gear [72] on the nozzle [20], driven by the gear [71] on a motor [76]. The aperture [25] is adjusted in unison by rotating a screw shaft [45] that raises or lowers a cover [30] over the nozzle [20]. The motor [76] driving the gear [71] and the motor [40] driving the screw shaft [45] respond to signals sent through an electronic control board. While the embodiment of FIG. 3 may be sized to similar dimensions as FIG. 2, it is possible to create a grand pump and nozzle for a mass dispersion. Broad, regional weather data can be sent to a central computer where it is processed and analyzed. When conditions indicate that warm, moist air will collide with a cold front, possibly causing severe weather, then remote signals will be sent to activate a pump, rotate the nozzle [20] and adjust the aperture [25]. The rotation of the nozzle could be a spin, slide or any movement of the nozzle [20] in addition to adjustment of the aperture [25]. Water pumped through the inlet pipe and into the nozzle [20] (as indicated by the arrows) will be forced through the shaped holes [94] in the cap [99] of the nozzle [20]. As fluid is forced out the shaped holes [94] in the cap [99] of the nozzle [20] and is further shaped into a spiral by the molded shape [98] inside the cover [30], the plume of fluid dispersed out the aperture [25] will swirl.

The swirling fluid dispersed [96] will form a small funnel cloud that generates further lift. The benefits will be collision of fluid droplets over time after dispersion and to hold the plume or cloud of dispersed fluid more tightly. It can be tested whether the funnel cloud created is sufficient to deliver warm moisture into an approaching cold front for the purpose of dissipating the differential energy and thereby reducing the threat of severe weather.

In an alternate embodiment, a heating element is introduced within the nozzle and activated differentially according to the weather conditions to provide flash heating to the fluid as it is dispersed. The heating element is an example of one or more additional features that are integrated to the nozzle to work in unison, collaboratively with, adjustment of the aperture. These features may reinforce, control, limit or refine the dispersion resulting from adjustment of the aperture. The effect of the heating element is to further suspend the fluid, cause lift and dissipate the weather differential.

FIG. 3c shows an exploded view of the component parts of the adjusting nozzle [20] shaped to disperse a swirl or funnel cloud. The inlet pipe [60] has molded screw threads that secure an inner bracket [53]. The motor [76] that rotates the nozzle [20] is secured to the inner bracket [53] with a band or tie [59]. The nozzle [20] is held flush by the several brackets and sleeves to the inlet pipe [60] spaced with a rubber grommet or washer band [92]. An O-ring [68] within the inner bracket [53] surrounds the nozzle [20] to ensure a tight fit that prevents leaks. The motor [76] rotates a gear [71], secured by a cap [84], the gear [71] interlocked to the gear [72] on the nozzle [20]. The gears and nozzle [20] are held in place by an inner sleeve [52] that includes an O-ring [68] to help the nozzle [20] turn and ensure no leak of fluid. The inner sleeve [52] is slanted at the top to assist the shaped dispersion of fluid from the nozzle [20]. The construction of nozzle [20] and rotation motor [76] and inner bracket [53] and inner sleeve [52] is held together by an outer lower bracket [55] and an outer upper bracket [54] that are bolted together with bolts [22] and nuts [23]. A rubber washer band [91] spaces and seals tight the outer lower bracket [55] and outer upper bracket [54]. The motor [40] that moves the cover [30] is secured to the outer upper bracket [54] with bands or ties [59]. The motor [40] rotates a screw shaft [45] that is interlocked to the screw threads [46] on the cover [30]. The screw shaft [45] is fixed on the motor shaft with a retaining ring and screw [47]. The cover [30] retains O-rings [51] to slide easily on the inner sleeve [52]. The nozzle [20] features a shaped cap [99] that will disperse the fluid in a swirl pattern within the cover [30], with the objective to be further directed by the molded shape [98] inside the cover [30] so that the plume of fluid dispersed will swirl.

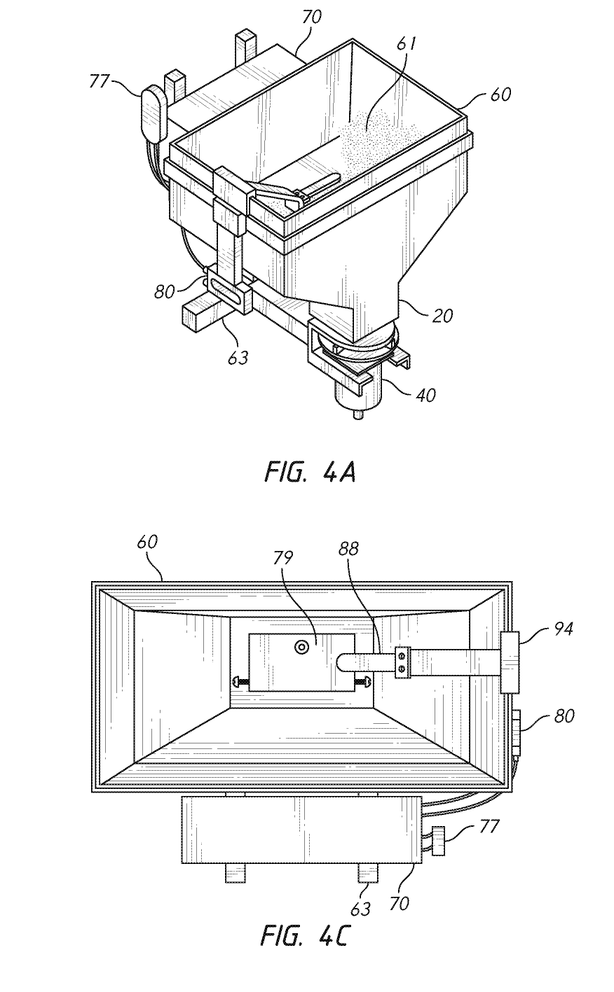

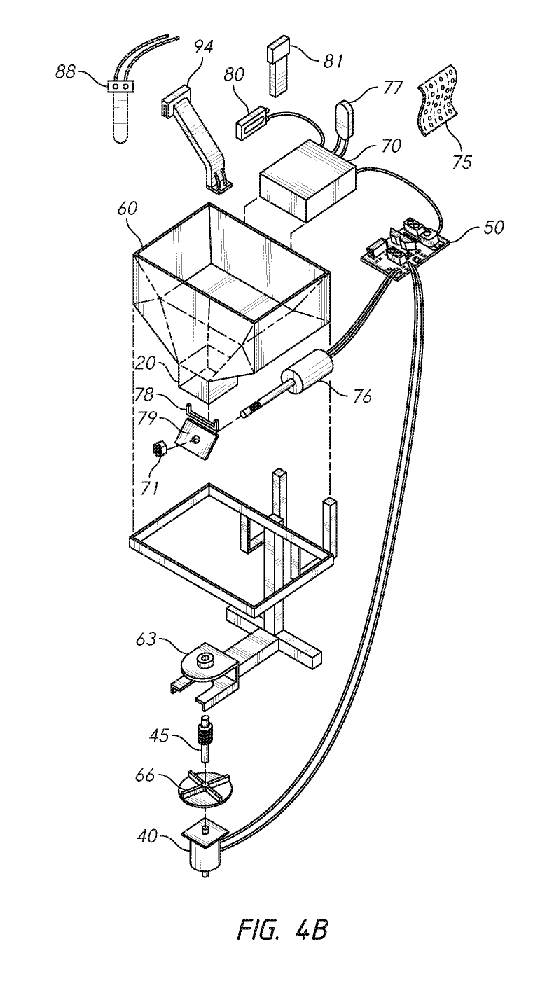

FIG. 4a shows an angled view of a salt dispenser suitable to attach to a truck and including an adjusting flap over the dispensing nozzle [20] to control the aperture for dispersing salt. The funnel [20] of the container [60] holding the salt [61] is at the bottom of the container [60] where the salt [61] will flow by gravity. The container [60] and adjusting apparatus is attached to a truck with a bracket [63]. A level sensor [80] measures the incline or decline of the road and sends a signal to the computer [70] that processes the information and sends a signal through an electronic control board to adjust the aperture within the funnel [20], as will be further described. The computer [70] has a transmitter and receiver [77] to communicate remotely with the equipment in the truck cab and a central control station. The transmitter and receiver [77] can receive signals from an operator in the truck cab, either the driver or a separate operator managing the equipment there, or from a central control station, so that the computer [70], transmitter and receiver [77], and electronic control board that are part of the apparatus of the salt dispenser will process its own default direction to adjust the aperture, but then also permit ongoing monitoring and any combination of manager, central station computer, or local operator to provide an override code or instructions, programming or interrupts to alter the signals or direction that adjusts the nozzle aperture. At least one of the activities or measurements can be logged to a data file and over time this data log can be analyzed to create predictive modeling that may be part of the computer programming to adjust the nozzle aperture. The activity of the apparatus or measurement of the resulting effects of the fluid dispersion can be integrated with further sensing of one or more independent variables to further adjust the aperture or additional features. All of the information from the activity or measurement of the resulting effect of the fluid dispersion can be formed into a presentation or display that assists management, or could even be viewed by the public on an internet site.

FIG. 4b shows an exploded view of the component parts of the apparatus to adjust the aperture of a salt dispenser suitable to attach to a truck. A level sensor [80] is attached to the container [60] and measures the incline or decline of the road to send a signal to the computer [70]. The computer also receives signals through a receiver and transmitter [77] from the truck driver and a central control station. The signals can include preprocessed directions that reflect a central strategy for several trucks with the adjusting apparatus units. The signals can also include measurements of remote sensors or predictive models and information, such as the time until precipitation is expected to freeze on the local road. The computer [70] determines directions based on computer code [75] and sends signals through an electronic control board [50] that sends signals to solenoid [76] and motor [40]. Within the funnel [20] at the bottom of the container [60] is a flap [79] hinged on a retaining bar [78] fixed inside the funnel [20]. The solenoid [76] will extend or contract according to the signal from the electronic control board [50] and push or pull the flap [79]. The solenoid [76] is fixed to the flap [79] with the nut [71]. As the solenoid [76] pushes or pulls the flap [79] then the flap [79] will open or close to change the aperture within the funnel [20] and control how much salt flows through. Within the lower portion of the apparatus, the motor [40] turns a deflecting flange or screen [66] and screw shaft [45]. The motor [40] is held in place at the bottom of the bracket [63] and where the screw shaft [45] can extend through a retaining hole into the bottom of the funnel [20]. The signals sent from the electronic control board [50] to the motor [40] and the solenoid [76] will control the flap [79] and screw shaft [45] to control the rate of flow and dispersion characteristics of the salt. In this embodiment, the weather characteristics of the local road and broader regional area can be used to adjust the aperture, and therefore the dispersion rate and characteristics. As example, where the truck descends a hill into a valley, and on a hill that would be more dangerous to drive, the signals can direct the apparatus to disperse more salt and in a broader pattern. In FIG. 4b, a heating element [88] is fixed to the container [60] by a bracket [94] and wired to the electronic control board [50]. The heating element [88] can be further directed to heat the salt for the most critical areas, such as the hill or decline previously described. By heating the salt, it may be possible to have the salt stick to forming ice, to be more effective and to be less likely to blow or bounce away. Another feature that could be added is a proximity sensor for pedestrians that will temporarily interrupt the dispensing by closing the flap; it will be more efficient and productive to interrupt the salt dispensing operation in this manner than to shut down power or other aspects of the machinery, and this provides a safety benefit. Another feature that could be added is to interrupt the salt dispensing when the truck comes to a stop or slows below a set speed; a signal from the speedometer or brake pedal can direct the apparatus to close the flap, and this will save salt and prevent harmful effects on local roads where the truck may need to stop at a red light or back up. The truck driver or operator in the truck cab can have equipment to send an interrupt signal that will close the flap, adjusting the aperture, as an override that is a general safety feature and would cover unforeseen circumstances. In this manner, it is possible to add features to the aperture adjustment to provide a more robust effect.

An alternate embodiment could lightly spray the salt with warm water as the salt is dispersed, for the purpose of making the salt stick to the ground or icy road where the salt is dispersed. The inclusion of an additional fluid is an additional feature similar to the heating element, and the device for this additional feature can be integrated to the apparatus. The feature may reinforce, control, limit or refine the dispersion resulting from adjustment of the aperture.

FIG. 4c shows a top down view of the salt dispenser with apparatus to adjust the aperture. A level sensor [80] is attached to the container [60] and measures the incline or decline of the road to send a signal to the computer [70]. The computer [70] is fixed to the back of the container [60] by the bracket [63] that also attaches the entire apparatus to the truck. The computer [70] uses a transmitter and receiver [77] to communicate with the truck driver and a central control station. At the bottom of the container [60] is a flap [79] that is controlled through an electronic control board from the computer [70].

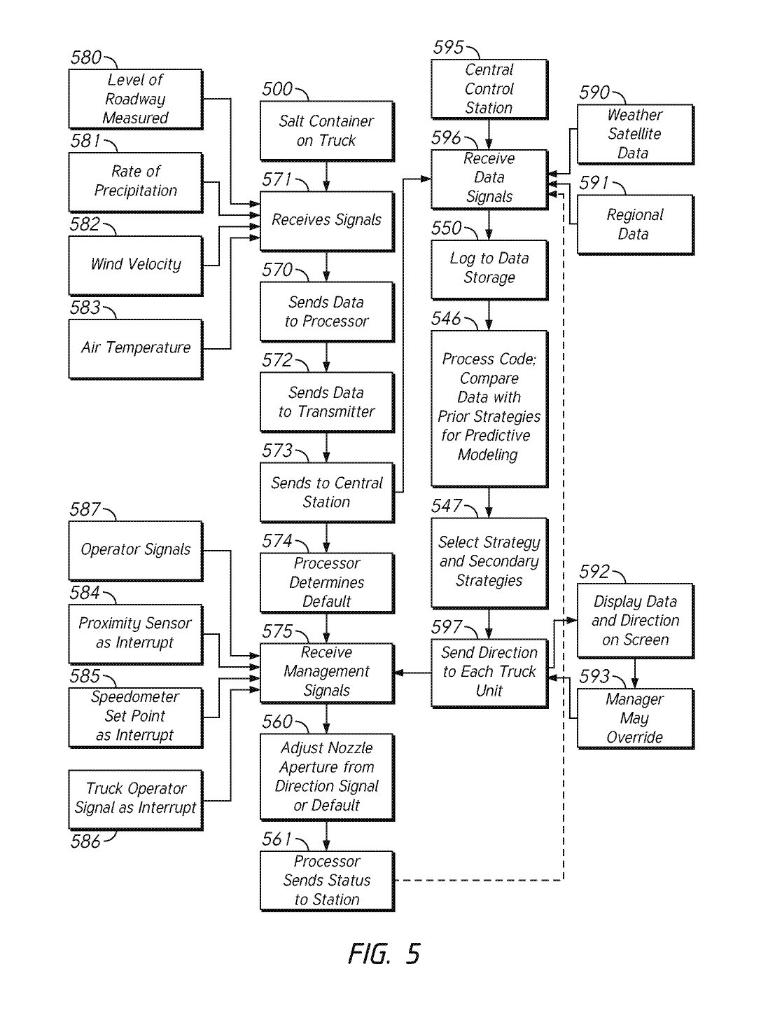

FIG. 5 shows a decision protocol for an alternative embodiment of the system for an individual truck salt dispensing apparatus [500] similar to an embodiment depicted in FIG. 4. If an individual truck does not receive any signal from the central station [595] then the individual truck [500] will default to its individual decision protocol.

In FIG. 5, the individual truck apparatus [500] has a processor receiving signals [571] from sensors such as a level switch [580]. A simple mercury level switch can measure the incline or decline of a roadway and send signals when the mercury flows to one side or the other. The roadway level sensor [580] measuring elevation, a rain gauge or device measuring the rate of precipitation [581], an anemometer measuring wind velocity [582], and a thermometer [583] are examples of sensors that can be attached through electric wires or of sensors that can send signals to the communications receiver that is receiving signals [571]. The system can receive any combination of connected, remote or networked signals from sensors and management. The roadway level [580] would indicate if the particular truck apparatus [500] should open the flap more to increase the aperture and disperse more salt over that stretch of roadway, for example. The individual truck apparatus [500] receives signals [571] sent from connected sensors, remote sensors from fixed weather sites, roadway locations or other truck units, and sends this group of data to its processor [570]. The processor sends this data packet to its transmitter [572] to transmit [573] to the central station [595]. The processor processes a default direction [574] by comparing the sensor measurements to set points.

The central station [595] receives data signals [596] from each individual truck transmission [573] and also receives signals [596] sent from weather satellite signals [590], regional data feeds by computer or internet [591] and other information sources. This external information can formulate a signal that will adjust the nozzle aperture. The processor logs this data to its center data storage device [550] and proceeds to process code [546]. In processing code [546], the processor pulls historical data from the data storage device [550], pulls prediction models and strategic algorithms and the current data for comparison. The processor can also compare current data with prior strategies to assign or alter odds or probabilities that it attaches to strategies as an indication of the success of that strategy, thereby refining its predictive models. From this processing [546], the processor will select a preferred strategy along with secondary strategies and sub-optimal strategies and even disadvantageous actions [547]. The processor may assign probabilities to the rank order of strategies, and may use a random number generator to select a second rank strategy or even a suboptimal strategy to test empirically the soundness of the processor's decision algorithms, so to further refine its predictive modelling. The processor of the central station [595] will display the data and rank order of strategies selected on a computer monitor or display screen for a manager's review [592]. The manager can choose to monitor or can intervene to override the strategy selected. The processor will then proceed to employ its strategy selected, or alter the strategy and direction if a manager interrupts and commands the processor to do so. The processor sends the direction for each individual truck apparatus [500] by transmitter [597] to the receiver for each individual truck apparatus [500], which receives its direction signal [575]. The processor also sends to the display screen a report of the information on directions that were transmitted to each individual truck, and this is displayed for the manager review [592]. A similar summary or individualized display can be created in the truck cab for review by the truck driver or operator. And any portion or entirety of this information could be transmitted to the internet, websites or virtual private network for review and interaction by interested parties.

Each individual truck apparatus [500] will adjust its nozzle [560] and add any features such as a heating element based on the signal received [575] from the direction of the central station [597], or based on its default selection based on set points [574] if no signal was received. If a person approaches the dispenser unit while it is operating, a proximity indicator can cause an interrupt [584] to have a signal sent to the processor of the individual apparatus [500]. In a similar way, the truck driver or another person acting as local operator can determine from the operation of the salt dispenser and whatever local conditions are occurring or obstructions may be in the roadway or pedestrians in the proximity that an interrupt signal or an adjustment of the aperture and features may be appropriate and therefore the signal sent [586] as an override. In particular, it would be beneficial to have the dispensing halted or slowed when the truck comes to a stop at a red light on local roadways. An effective method to accomplish this is to close the flap that effectively constricts the aperture, so that the remainder of the equipment is still running and operating and can resume immediately as the truck accelerates. The apparatus can be programmed for this type of interrupt automatically [585] when the speedometer falls below 5 miles per hour or reaches 0, as example, but it is also possible to have the operator provide an interrupt. The status of the individual truck apparatus [500], in terms of nozzle operation, features and other device functions, and local weather conditions as the sensors measure, is transmitted [561] to the central station [595]. The information of the current status is received [596] by the central station [595] and merged with the continuous stream of data on sensor readings received [596] by the central station [595]. Therefore the loop of activity and measurements and processing of decision protocols is an ongoing process.

The descriptions contained herein of the specific embodiments reveal the general nature of the invention that others can, by applying knowledge within the skill of the art, readily modify and/or adapt for various applications of such specific embodiments, without undue experimentation, without departing from the general concept of the present invention. Therefore, such adaptation and modifications are intended to be within the meaning and range of equivalents of the disclosed embodiments, based on the teaching and guidance presented herein. It is understood that the phraseology or terminology herein is for the purpose of description and not of limitation, such that the terminology or phraseology of the present specification is to be interpreted by the skilled artisan in light of the teachings and guidance. While the foregoing has been set forth in considerable detail, it is to be understood that the drawings and detailed embodiments are presented for elucidation and not limitation. Design variations, especially in matters of shape, size and arrangements of parts may be made but are within the principles of the invention. Those skilled in the art will realize that such changes or modifications of the invention or combinations of elements, variations, equivalents or improvements therein are still within the scope of the invention as defined in the appended claims and their equivalents.

1-26. (canceled)

27. An apparatus to adjust an internal shape of a nozzle to disperse a fluid, said apparatus comprising:
a nozzle mechanism operable to adjust an internal shape within a cover of a nozzle to disperse a fluid;
a sensor to measure the change of an environmental event; and
a control in communication with the sensor, the control operable to adjust the nozzle mechanism to adjust said internal shape based on the environmental event.

28. The apparatus as recited in claim 27, wherein the internal shape is adjustable to change a shape of the dispensed fluid.

29. The apparatus as recited in claim 27, wherein the internal shape is adjustable via shaped holes within an internal structure of the nozzle mechanism.

30. The apparatus as recited in claim 27, wherein the internal shape is adjustable via a shaped cap displaced from an aperture.

31. The apparatus as recited in claim 27, wherein the internal shape includes a spiral shape.

32. The apparatus as recited in claim 27, wherein the internal shape is adjustable such that a size of the aperture and an internal shape of the nozzle are adjustable to achieve a target range of droplet sizes for the fluid it disperses within a changing environment of temperature, pressure and fluid density.

33. The apparatus as recited in claim 27, wherein the internal shape is adjustable such that more than 50% of droplets of said fluid dispersed will remain suspended in a gas mixture for a time greater than would elapse if said droplets fell at terminal velocity by force of gravity but more than 50% of said droplets will return to the source of said fluid or an adjacent area and not remain suspended indefinitely if unimpeded.

34. The apparatus as recited in claim 27, wherein the environmental event includes at least one of sunlight, moisture, salinity, pH, wind or current.

35. The apparatus as recited in claim 27, wherein the apparatus includes a multiple of nozzles that are networked together to deliver a total effect over an area.

36. The apparatus as recited in claim 27, wherein at least one of the activity of said apparatus or said system or a measurement of the resulting effect of said fluid dispersion is logged to a data file.

37. The apparatus as recited in claim 27, wherein at least one of the activity of said apparatus or said system or a measurement of the resulting effect of said fluid dispersion is integrated to adjust said apparatus or said system.

38. The apparatus as recited in claim 27, wherein at least one of the activity of said apparatus or said system or a measurement of the resulting effect of said fluid dispersion is formed into a presentation or display for management or for viewing by interested parties.

39. A method to operate an apparatus to adjust a nozzle to disperse fluid, comprising:
determining a change of an environmental event;
determining historical data for at least one effect of the fluid that will disperse from the nozzle;
adjusting a nozzle mechanism to adjust an internal shape of the nozzle based on the change of the environment event, and the historical data.

40. The method as recited in claim 39, further comprising determining a set point for at least one effect of the fluid that will disperse from the nozzle.

41. The method as recited in claim 39, further comprising correlating the change of the environmental event and the historical data with a predictive paradigm for adjusting the nozzle mechanism.
